(19) United States
(12) Patent Application Publication
(10) Pub. No.: US 2025/0094159 A1
(43) Pub. Date: Mar. 20, 2025

(54) AN UPDATE ROLLBACK FRAMEWORK FOR PATROLLING MEMBERS

(71) Applicant: Gensol Electric Vehicles Private Limited, Pune (IN)

(72) Inventor: Pratik Gupta, Mumbai (IN)

(73) Assignee: Gensol Electric Vehicles Private Limited, Pune, MH (IN)

(21) Appl. No.: 18/727,767

(22) PCT Filed: Feb. 6, 2023
(86) PCT No.: PCT/IN2023/050118

§ 371 Date: Jul. 10, 2024

(30) Foreign Application Priority Data
Feb. 7, 2022 (IN) 202221006466

(51) Int. Cl. G06F 8/65

(52) U.S. Cl. CPC G06F 8/65

(57) ABSTRACT

An update rollback framework, for patrolling members is disclosed. Said framework broadly comprises an at least a bootloading member (103). Said at least one bootloading member (103) is communicatively associated with an at least an application member. Said at least one application member broadly comprises a plurality of storage members. Said plurality of storage members includes: a first storage member (101); and a second storage member (102). Based on certain checks, if an updated program is detected as functioning, without any errors (or faults, or issues), by said framework, no further changes are made. On the other hand, if errors (or faults, or issues) are detected, said at least one bootloading member (103) is configured to automatically execute a non-updated program. The disclosed framework offers at least the following advantages: is simple in construction; is cost-effective; and enables updated programs to be sent out, without worrying about errors or bugs.

### FIELD OF THE INVENTION

The present disclosure is generally related to patrolling members. Particularly, the present disclosure is related to the updating of patrolling members. More particularly, the present disclosure is related to an update rollback framework, for patrolling members.

### BACKGROUND OF THE INVENTION

Many patrolling members have a self-configuring feature, which enables reconfiguring parts of their own memories. This enables updating of firmware, with memory interfaces (or communication pathways), depending on the product.

Typically, a bootloading member decides, if updates are to be carried out, or not. If yes, the bootloading member rewrites a memory, on an application member. Most electronic products have a bootloading member, which communicates with a device, through a serial link (or via a USB interface), in order to carry out updates.

However, problems arise during use of complex memory interfaces (memory cards, wireless interfaces, Wi-Fi, Bluetooth, and/or the like). Protocols being used, by these, are complex, and take up more bootloading member space, more time, and also increase chances of errors, which include, but are not limited to: bugs; stability issues; and/or the like.

Implementing complex communications protocols, in the bootloading member, requires a lot of development effort and time, which restricts the flexibilities of the interface, to the one being developed.

Further, if unstable (or faulty) updates are rolled out, they may cause stability issues, leading to incorrect functioning (or stopping of functioning).

There is, therefore, a need in the art, for: an update rollback framework, for patrolling members, which overcomes the aforementioned drawbacks and shortcomings.

### SUMMARY OF THE INVENTION

An update rollback framework, for patrolling members is disclosed. Said framework broadly comprises an at least a bootloading member. Said at least one bootloading member is communicatively associated with an at least an application member.

Said at least one application member broadly comprises a plurality of storage members. Said plurality of storage members includes: a first storage member; and a second storage member.

Said first storage member is configured to hold (or store) an updated program (for example, a program, which corresponds to a newly released version of a firmware), while said second storage member is configured to hold (or store) a non-updated program (a program, which corresponds to a version of said firmware that prevailed, prior to said newly released version).

Said at least one bootloading member is configured to load (or transfer, or copy, or execute, or download) said updated program, onto (or on) said first storage member.

Said at least one bootloading member is also configured to perform a hard reset of a patrolling member, where said updated program was loaded (or transferred, or copied, or executed, or downloaded), upon receiving a notification that said updated program is faulty (contains errors, or faults, or issues).

Said at least one bootloading member is also configured to load said non-updated program, if said hard reset is performed.

Said at least one bootloading member is also configured to load (or transfer, or copy, or execute) said updated program, onto (or to) to said second storage member, upon receiving a notification that said updated program is not faulty (does not contain errors, or faults, or issues).

Said at least one bootloading member is also configured to perform a soft reset of said patrolling member, where said updated program was loaded (or transferred, or copied, or executed).

The disclosed framework offers at least the following advantages: is simple in construction; is cost-effective; and enables updated programs to be sent out, without worrying about errors or bugs.

### BRIEF DESCRIPTION OF THE DRAWINGS

FIG. 1 illustrates an update rollback framework, for patrolling members, in accordance with an embodiment of the present disclosure.

### DETAILED DESCRIPTION OF THE INVENTION

Throughout this specification, the use of the words “comprise” and “include”, and variations, such as “comprises”, “comprising”, “includes”, and “including”, may imply the inclusion of an element (or elements) not specifically recited. Further, the disclosed embodiments may be embodied, in various other forms, as well.

Throughout this specification, the use of the word “framework” is to be construed as: “a set of technical components (also referred to as “members”) that are communicatively and/or operably associated with each other, and function together, as part of a mechanism, to achieve a desired technical result”.

Throughout this specification, the use of the words “communication”, “couple”, and their variations (such as communicatively), is to be construed as being inclusive of: one-way communication (or coupling); and two-way communication (or coupling), as the case may be, irrespective of the directions of arrows, in the drawings.

Throughout this specification, where applicable, the use of the phrase “at least” is to be construed in association with the suffix “one” i.e. it is to be read along with the suffix “one”, as “at least one”, which is used in the meaning of “one or more”. A person skilled in the art will appreciate the fact that the phrase “at least one” is a standard term that is used, in Patent Specifications, to denote any component of a disclosure, which may be present (or disposed) in a single quantity, or more than a single quantity.

Throughout this specification, the use of the word “plurality” is to be construed as being inclusive of: “at least one”.

Throughout this specification, the use of the phrase “patrolling member”, and its variations, is to be construed as being inclusive of: “a control unit, which is configured to facilitate monitoring and controlling of a system, an apparatus, a device, a framework, and/or the like, including, but not limited to: a microcontroller; a Single Board Computer; a System on Chip; and/or the like”.

Throughout this specification, the use of the phrase “update rollback framework”, and its variations, is to be construed as being inclusive of: “a framework that automatically executes a prior version of a program, if a newly released version of the program is detected as containing errors (or faults, or issues), in its functioning”.

Throughout this specification, the words “the” and “said” are used interchangeably.

Throughout this specification, the phrases “at least a”, “at least an”, and “at least one” are used interchangeably.

Throughout this specification, the phrases “user application” and “application member” are used interchangeably.

Throughout this specification, the phrases “application new” and “first storage member” are used interchangeably.

Throughout this specification, the phrases “application old” and “second storage member” are used interchangeably.

Throughout this specification, the phrase “bootloading member” and the word “bootloader” are used interchangeably.

Also, it is to be noted that embodiments may be described as a method. Although the operations, in a method, are described as a sequential process, many of the operations may be performed in parallel, concurrently, or simultaneously. In addition, the order of the operations may be re-arranged. A method may be terminated, when its operations are completed, but may also have additional steps.

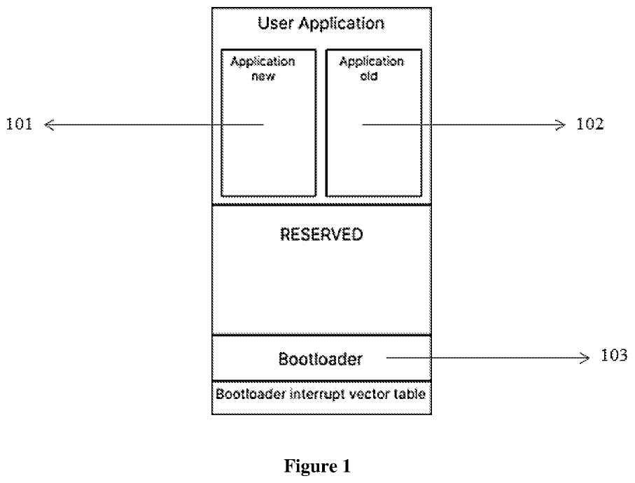

An update rollback framework, for patrolling members (also referred to as “framework”), is disclosed. In an embodiment of the present disclosure, as illustrated, in FIG. 1, the framework broadly comprises an at least a bootloading member (103). Said at least one bootloading member (103) is communicatively associated with an at least an application member.

Said at least one application member broadly comprises a plurality of storage members. Said plurality of storage members includes: a first storage member (101; for example, a memory); and a second storage member (102; for example, a memory). A person skilled in the art will appreciate the fact that the first storage member (101) and the second storage member (102) may be of any suitable type known in the art.

A person skilled in the art will also appreciate the fact that the at least one application member is configured to communicate with peripherals, and comprises libraries and protocols, which are required, to perform an update, via an interface, which includes, but is not limited to: USB; and/or Ethernet.

Said first storage member (101) is configured to hold (or store) an updated program (for example, a program, which corresponds to a newly released version of a firmware), while said second storage member (102) is configured to hold (or store) a non-updated program (a program, which corresponds to a version of the firmware that prevailed, prior to the newly released version).

After the updated program is ready, the at least one bootloading member (103) loads the same (or transfers the same, or copies the same, or executes the same, or downloads the same), onto (or on) the first storage member (101). The updated program and the non-updated program, which are held (or stored), by (or on) the first storage member (101) and the second storage member (102), respectively, are tracked (by the framework).

Based on certain checks, if the updated program is detected as functioning, without any errors (or faults, or issues), by the framework, no further changes are made.

For example, in case of an updated program, to an electric vehicle's motor controller, the certain checks include: communication, between a vehicle control unit and the motor controller. The certain checks are performed, to ensure that the integrity of the motor controller is intact, after the updated program is loaded (or transferred, or copied, or executed, or downloaded), and it is able to execute its functions normally.

Likewise, in case of an updated program, to a mobile device's Bluetooth module, the certain checks include: communication, with the Bluetooth module, to ensure that the same is active.

On the other hand, if errors (or faults, or issues) are detected, in the functioning of the updated program, by the framework, the at least one bootloading member (103) is configured to automatically execute the non-updated program.

Other features illustrated, in FIG. 1, are well-known to a person skilled in the art. For example, “RESERVED” denotes “reserved memory”.

A method of the framework's operation shall now be explained. After checking for initial parameters and integrity, and initialising the peripherals (these steps are well-known, to a person skilled in the art), the at least one bootloading member (103) loads (or transfers, or copies, or executes, or downloads) the updated program, onto (or on) the first storage member (101).

The above step is performed, through any available communication protocol, including, but not limited to: UART; I2C; I2S; USB; Wi-Fi; and/or the like.

Integrity of the updated program is checked, to ensure that the same is functioning properly. If faults (or issues, or errors) are detected, by the framework, the same are notified, to the at least one bootloading member (103), via an interrupt or a flag, following which, the at least one bootloading member (103) is configured to perform a hard reset of a patrolling member, where the updated program was loaded (or transferred, or copied, or executed, or downloaded).

During the hard reset, the at least one bootloading member (103) automatically loads (or automatically executes) the non-updated program, which is held (or stored), by (or on) the second storage member (102). This ensures that the integrity of the patrolling member remains intact and it continues to function, without any faults (or issues, or errors).

On the other hand, if the updated program is detected as functioning properly, without any faults (or issues, or errors), by the framework, the same is again notified, to the at least one bootloading member (103), via another flag, following which, the at least one bootloading member (103) loads the same (or transfers the same, or copies the same, or executes the same), onto (or on) the second storage member (102).

Subsequently, the at least one bootloading member (103) is configured to perform a soft reset of the patrolling member, where the updated program was loaded (or transferred, or copied, or executed, or downloaded).

A use case of the framework is sending firmware updates to electric vehicles. An electric vehicle has a lot of sophisticated systems running in the background, which are crucial to various aspects of the vehicle, including, but are not limited to: battery safety; driver safety and safety of passengers; and/or overall functioning of the vehicle. As a result, it is very important to make sure that any updated program, which is rolled out, is a stable version.

For example, if there is an updated program, to a vehicle control unit, it is checked whether the vehicle is being charged or not. This ensures that the updated program is loaded (or transferred, or copied, or executed, or downloaded), at a non-operational time.

The at least one bootloading member (103) receives instructions, to perform the update, via a digital input (or an interrupt). Alternatively, if the updated program is loaded (or transferred, or copied, or executed, or downloaded), at a vehicle service centre, by a technician, the same may be performed, via a JTAG connector.

Another use case is in mobile devices. Often, an updated program is rolled out, which may have passed testing, but has bugs when it is rolled out, which obstruct the proper functioning of a mobile device.

The disclosed framework offers at least the following advantages: is simple in construction; is cost-effective; and enables updated programs to be sent out, without worrying about errors or bugs.

A person skilled in the art will appreciate the fact that the framework, and its various components, may be made of any suitable materials known in the art. Likewise, a person skilled in the art will also appreciate the fact that the configurations of the framework, and its various components, may be varied, based on requirements.

Implementation of the disclosure can involve performing or completing selected tasks manually, automatically, or a combination thereof. Further, according to actual instrumentation of the disclosure, several selected tasks could be implemented, by hardware, by software, by firmware, or by a combination thereof, using an operating system.

For example, as software, selected tasks according to the disclosure could be implemented, as a plurality of software instructions being executed, by a computing device, using any suitable operating system.

In yet another embodiment of the disclosure, one or more tasks, according to embodiments of the disclosure, is (or are) performed, by a data processor, such as a computing platform, for executing a plurality of instructions. Further, the data processor includes a processor, and/or non-transitory computer-readable medium, for storing instructions and/or data, and/or a non-volatile storage, for storing instructions and/or data. A network connection, a display, and/or a user input device such as a keyboard (or mouse) are also provided.

It will be apparent to a person skilled in the art that the above description is for illustrative purposes only and should not be considered as limiting. Various modifications, additions, alterations, and improvements, without deviating from the spirit and the scope of the disclosure, may be made, by a person skilled in the art. Such modifications, additions, alterations, and improvements should be construed as being within the scope of this disclosure.

### LIST OF REFERENCE NUMERALS

101—First Storage Member
102—Second Storage Member
103—At Least One Bootloading Member

We claim:

1. An update rollback framework, for patrolling members, comprising:
an at least a bootloading member (103) that is communicatively associated with an at least an application member; and
said at least one application member that comprises a plurality of storage members; said plurality of storage members including:
a first storage member (101) that is configured to hold an updated program; and
a second storage member (102) that is configured to hold a non-updated program,
with said at least one bootloading member (103) being configured to:
download said updated program, onto said first storage member (101);
perform a hard reset, upon receiving a notification that said updated program is faulty;
execute said non-updated program, if said hard reset is performed;
transfer said updated program, to said second storage member (102), upon receiving a notification that said updated program is not faulty; and
perform a soft reset, after transferring said updated program, to said second storage member (102).
